(19) United States
(12) Patent Application Publication
(10) Pub. No.: US 2007/0121901 A1
(43) Pub. Date: May 31, 2007

(54) Providing answering message options for answering calls

(75) Inventors: Stinson S. Mathal, Wheaton, IL (US); Robin J. Thompson, Batavia, IL (US); George Varghese, Elmhurst, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/289,900

(22) Filed: Nov. 30, 2005

(51) Int. Cl. H04M 3/00; H04M 5/00

(52) U.S. Cl. 379/265.09

(57) ABSTRACT

Devices, networks, and methods are disclosed for providing a plurality of answering message options to a called party for answering an incoming call. When a call is received in a called device, the called device identifies a plurality of answering messages predefined by the called party. The called device then provides answering message options to the called party based on the identified answering messages. The called party selects one of the answering message options. Responsive to the selection by the called party, the called device and/or the communication network transmits an answering message to the calling party. The answering message in essence “answers” the call for the called party. The called party does not actually have to speak into the called device to answer the call.

### BACKGROUND OF THE INVENTION

1. Field of the Invention

The invention is related to the field of communication networks and, in particular, to the providing answering message options for answering calls. More particularly, when a called party receives a call, the called device provides a plurality of answering message options so that the called party can answer the call using one of the answering message options.

2. Statement of the Problem

For a typical voice or data call, a calling party places the call using his/her communication device (referred to herein as the calling device). The calling device forwards call signaling for the call to the communication network providing service to the calling party. The call signaling may by SS7 signaling for traditional circuit-based networks, or may be Session Initiation Protocol (SIP) messages for packet-based networks or IP multimedia subsystems (IMS) networks. A network element in the communication network receives the call signaling, and processes the call signaling to determine the called party for the call. The network element serving the calling device routes the call to the communication device of the called party (referred to herein as the called device), possibly through another network element serving the called device. Responsive to receiving the call, the called device provides call alerting to the called party. Call alerting typically comprises a series of rings, vibration, a customized ring tone, etc.

One problem with present communication devices and/or communication networks is that the called party has limited options for answering an incoming call. When the called party detects that a call has been received, the called party may answer the call and begin speaking. Unfortunately, answering a call in this manner may not be possible in some circumstances, such as if the called party is in a meeting, in a movie, etc. The called party may also have the call go to voice mail, such as by not answering the call, by activating a Do Not Disturb function, or by actively pushing a button. Unfortunately, the voice mail message may not convey any information on the present availability of the called party unless the called party continually updates his/her voice mail message.

It may be desirable to provide the called party with more options for answering a call.

### SUMMARY OF THE SOLUTION

The invention solves the above and other related problems by providing a plurality of answering message options to a called party responsive to receiving a call in the called device. The answering message options provide the called party with an alternative to traditional call answering.

In one embodiment of the invention, when a call is received in the called device, the called device identifies a plurality answering messages predefined by the called party. The called device then provides answering message options to the called party based on the identified answering messages, possibly along with providing traditional call alerting. The called party selects one of the answering message options for answering the call. The called device and/or the communication network transmit an answering message to the calling party responsive to the selection by the called party. The answering message may comprise a text message, a voice message, a video message, a picture message, or any other type of multi-media message. The answering message in essence “answers” the call for the called party. After transmitting the answering message to the calling party, the called device and/or the communication network may release the call or maintain the call.

The invention advantageously provides the called party with more options for answering a call. The called party is not limited to answering the call by speaking to the calling party, or routing the call to voice mail as is traditionally done. The called party may select one of a plurality of answering message options that are provided to the called party upon receiving the call. The answering message may indicate the present availability of the called party. As an example, one answering message option may be a text message that informs the calling party of the present availability of the called party, such as “I am in a meeting, will call you back in 10 minutes.” Another answering message option may be a voice message or announcement, such as “I am in a meeting, will call you back in 10 minutes.” Another answering message option may be a voice message or announcement, such as “I'm in a meeting right now, hold on while I excuse myself out of the meeting.”

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of providing options to a called party for answering a call in an exemplary embodiment of the invention.

FIG. 3 illustrates an exemplary embodiment of a called device.

FIG. 4 illustrates an exemplary screen displayed by a called device in an exemplary embodiment of the invention.

FIG. 5 is a signaling diagram illustrating an example where a network element provides a voice message to a calling party in an exemplary embodiment of the invention.

FIG. 6 is a signaling diagram illustrating an example where a called device provides a voice message to a calling party in an exemplary embodiment of the invention.

FIG. 7 is a signaling diagram illustrating another example where a network element provides a voice message to a calling party in an exemplary embodiment of the invention.

FIG. 8 illustrates another exemplary screen displayed by a called device in an exemplary embodiment of the invention.

FIG. 9 illustrates another exemplary screen displayed by a called device in an exemplary embodiment of the invention.

### DETAILED DESCRIPTION OF THE INVENTION

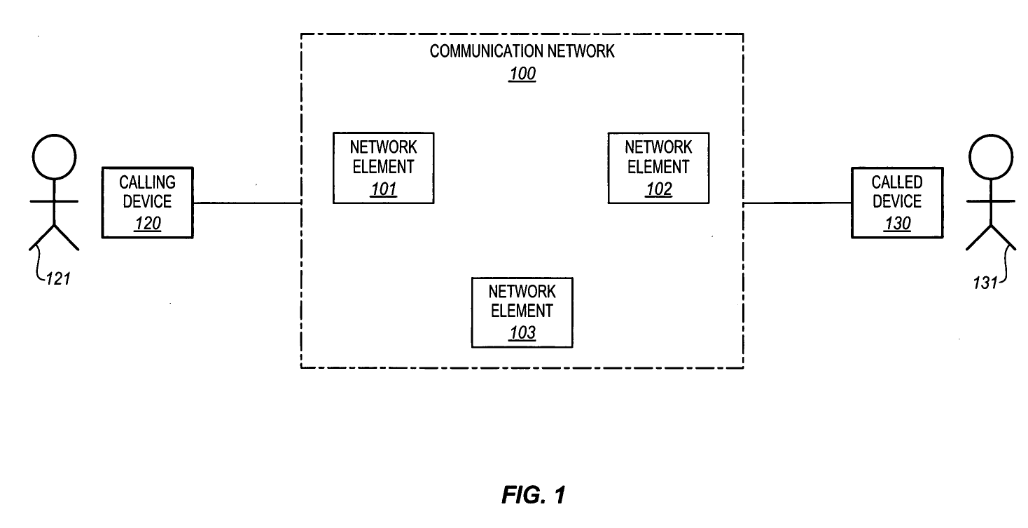

FIGS. 1-9 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 is operable to connect a call between a calling device 120 and a called device 130. Calling device 120 is being operated by a calling party 121. Calling device 120 may comprise a wireline device, a wireless device, a SIP-enabled VoIP device, or any other communication device. Called device 130 is being operated by a called party 131. Called device 130 may comprise a wireline device, a wireless device, a SIP-enabled VoIP device, or any other communication device. Called device 130 comprises an end user device, which comprises the device operated by called party 131.

Communication network 100 may comprise a wireless network, a wireline network, a circuit-based network, a packet-based network, an IMS network, or any other network or combination thereof. Communication network 100 includes a plurality of network elements 101-103. Network elements 101-103 may comprise any application, server, switch, etc, that provides a desired function for communication network 100. As an example, if communication network 100 is a wireless network, then network element 101 may comprise a Mobile Switching Center (MSC) serving calling device 120, network element 102 may comprise a MSC serving called device 130, and network element 103 may comprise a text message server or a multi-media server. In another example, if communication network 100 is an IMS network, then network element 101 may comprise a Serving-Call Session Control Function (S-CSCF) serving calling device 120, network element 102 may comprise an S-CSCF serving called device 130, and network element 103 may comprise an application server providing any desired service. Communication network 100 may include more network elements or other systems or devices not shown in FIG. 1 as need to provide a desired functionality.

Called party 131 defines a plurality of answering messages for answering calls. An answering message comprises any message, signal, or information for answering an incoming call for called party 131. The answering message may comprise a text message, a voice message, a video message, a picture message, or any other type of multi-media message (assuming calling device 120 is properly equipped to receive such messages). As an example, called party 131 may record one or more voice messages for answering a future incoming call. Called party 131 may also generate one or more text messages for answering a future incoming call. The answering messages may be stored locally in a memory of called device 130, may be stored remotely on one or more of the network elements 101-103 of communication network 100, or both.

Once defined, the answering messages are available to called party 130 for answering an incoming call. Assume that calling party 121 subsequently places a call to called party 131 through calling device 120. Communication network 100 receives the call to called party 131 and routes the call to called device 130. The following describes a method of providing answering message options to called party 131 for answering the call.

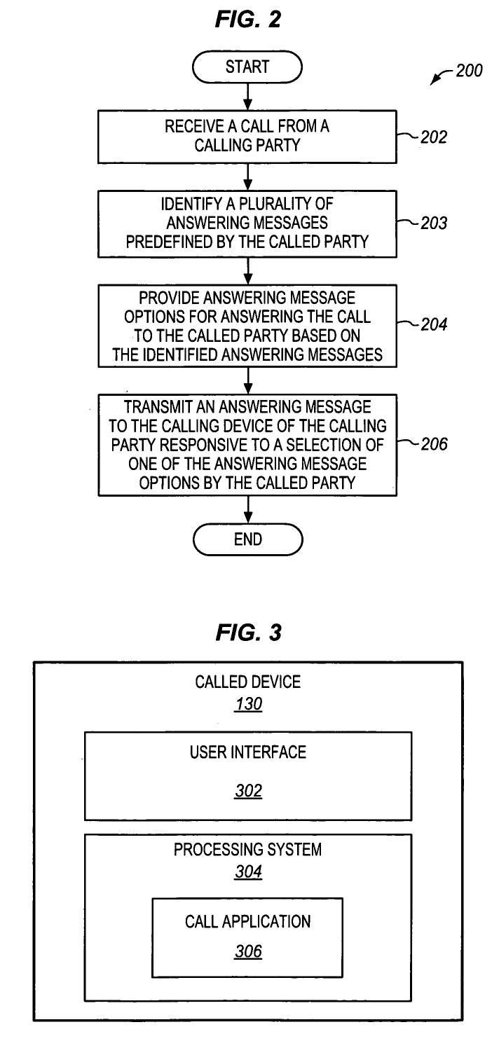

FIG. 2 is a flow chart illustrating a method 200 of providing options to called party 131 for answering an incoming call in an exemplary embodiment of the invention. The steps of the flow chart in FIG. 2 are not all inclusive and may include other steps not shown.

In step 202 of method 200, called device 130 receives the call from calling party 121. Called device 130 may receive the call by receiving call signaling for the call, such as ISDN User Part (ISUP) signaling, SIP messages, or some other signaling protocol.

In step 203, called device 130 identifies a plurality of answering messages predefined by called party 131 responsive to receiving the call. Called device 130 need not identify the actual content of the answering messages, just any indication of the answering message. For instance, called device 130 may identify a title of the answering messages, a description of the answering messages, etc. Called device 130 may also identify a location for the answering messages, such as a local memory address, or network address in communication network 100.

In step 204, called device 130 provides answering message options for answering the call to called party 131 based on the identified answering messages. Called device 130 may also provide call alerting responsive to receiving the call. The answering message options are any indications of the predefined answering messages identified by called device 130 to be available to called party 131 for answering the call. For instance, called device 130 may provide the answering message options as a menu indicating the answering messages available to called party 131. Called device 130 displays the menu of answering messages to called party 131, and allows for real-time selection of the answering messages by called party 131 that are displayed in the menu. Called device 130 may alternatively provide the answering messages options to called party 131 audibly, and use speech recognition to allow called party 131 to make the selection. Called device 130 may provide the answering message options in any desired format.

After called device 130 provides the answering message options, called party 131 may select one of the answering message options. In step 206, an answering message is transmitted to calling device 120 of calling party 121 responsive to a selection of one of the answering message options by called party 131. The answering message may indicate the present availability of called party 131 for answering the call, or indicate anything else predefined by called party 131.

The answering message may be transmitted by called device 130 in one embodiment. In another embodiment, the answering message may be transmitted by a network element 101-103 of communication network 100. In this instance, called device 130 transmits an answering message indicator of the selection of one of the answering message options by called party 130 to a network element 101-103. The receiving network element 101-103 then transmits the answering message to calling device 120 responsive to receiving the answering message indicator.

After transmitting the answering message to calling party 121, called device 130 and/or communication network 100 may release the call. Alternatively, called device 130 may maintain the call. Maintaining the call allows called party 131 to transmit another answering message to calling party 121 or speak to calling party 121.

The answering message in essence “answers” the call for called party 131. Called party 131 does not have to actually speak into called device 130 in order to “answer” the call. Called party 131 may later speak to calling party 121 if the call is maintained, but called party 131 advantageously has more options available for answering the call than were previously provided.

FIG. 3 illustrates an exemplary embodiment of called device 130. Called device 130 is not limited to this embodiment, and may have other desired configurations. Called device 130 includes a user interface 302, a processing system 304, and a call application 306. User interface 302 comprises any system, devices, or components used to input data from a user and/or output data to a user. Examples of user interface 302 include a display, a keypad, a touch screen, a speaker, a pointing device, etc. Processing system 304 comprises any circuitry, logic, single processing device, or a group of inter-operational processing devices operable to execute code or instructions. Call application 306 may comprise a function, a process, or set of instructions or code stored on storage media. Call application 306 may be retrieved and executed by processing system 304. Called device 130 may include other systems, components, or devices not shown in FIG. 3.

Called device 130 may comprise any desired communication device. For instance, called device 130 may comprise a landline phone or a wireless phone. Called device 130 may comprise a circuit-based phone or a packet-based phone, such as a SIP-enabled VoIP phone. Called device 130 may comprise a soft phone, which is a PC or PC-type device executing a call application to emulate a phone.

When in operation, assume that called device 130 receives a call from calling device 120 of calling party 121 (see FIG. 1). Responsive to receiving the call, call application 306 when executed by processing system 304 identifies a plurality of answering messages predefined by called party 131. Call application 306 provides answering message options for answering the call to called party 131. Call application 306 may provide the answering message options in any desired format as described above for FIG. 2. Call application 306 may also provide call alerting to called party 131 in addition to the answering message options.

Call application 306 then transmits an answering message to calling device 120 of calling party 121 responsive to a selection of one of the answering message options by called party 131. The answering message may comprise a text message, a voice message, a video message, a picture message, or any other type of multi-media message (assuming calling device 120 is properly equipped to receive such messages). The answering message may indicate the present availability of called party 131, or indicate anything else predefined by called party 131.

After transmitting the answering message to calling party 121, call application 306 may release the call. Alternatively, call application 306 may maintain the call. Maintaining the call allows called party 131 to transmit another answering message to calling party 121 or speak to calling party 121.

If the answering message corresponding with the selected answering message option is store remote from called device 130 in communication network, then call application 306 transmits an answering message indicator of the selected answering message option to a network element 101-103 in communication network 100. The network element 101-103 receiving the answering message indicator then transmits the answering message to calling device 120.

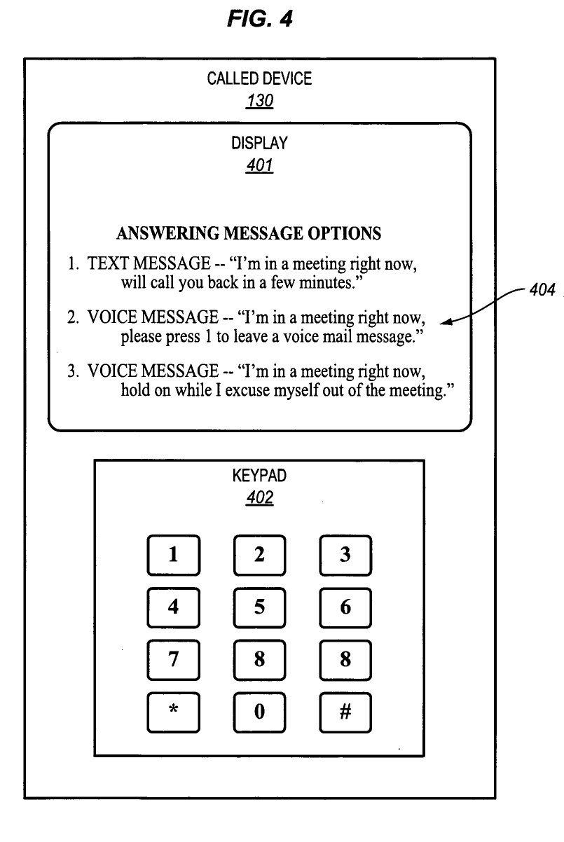

FIG. 4 illustrates called device 130 displaying an exemplary screen in an exemplary embodiment of the invention. The configuration of called device 130 and the displays generated by called device 130 are just examples and are in no way intended to limit the invention. Assume that user interface 302 includes a display 401 and a keypad 402 as shown in FIG. 4. Responsive to receiving a call, call application 306 generates a menu 404 and provides the menu 404 to called party 131 through display 401. Menu 404 includes a plurality of answering messages identified by call application 306 to be available to called party 131 for answering the call. The answering message options shown in FIG. 4 are just an example and the invention is not limited to this example.

The first answering message option is a text message that states “I'm in a meeting right now, will call you back in a few minutes.” The second answering message option is a voice message or announcement that states “I'm in a meeting right now, please press 1 to leave a voice mail message.” The third answering message option is a voice message or announcement that states “I'm in a meeting right now, hold on while I excuse myself out of the meeting.”

Menu 404 is selectable by called party 131. For instance, to select the first answering message option, called party 131 may press “1” on the keypad 402. To select the second answering message option, called party 131 may press “2” on the keypad 402. Any other selection mechanism may be used.

If called party 131 selects the first answering message option, then call application 306 (see FIG. 3) initiates the process of transmitting the text message to calling party 121. As an example, call application 306 may enable a text-based IM session with calling party 121, and transmit the text message indicated in the first answering message option to calling party 121.

If called party 131 selects the second answering message option, then call application 306 (see FIG. 3) initiates the process of transmitting a voice message to calling party 121 stating “I'm in a meeting right now, please press 1 to leave a voice mail message.” In one embodiment, call application 306 stores the predefined voice message of the second answering message option. Responsive to receiving the call, call application 306 transmits the voice message over the bearer channel established for the call to calling party 121. Call application 306 then releases the call.

In another embodiment, a network element 101-103 in the communication network 100 stores the predefined voice message of the second answering message option. Responsive to receiving the call, call application 306 transmits an answering message indicator to the appropriate network element 101-103 storing the voice message. Responsive to receiving the answering message indicator, the network element 101-103 transmits the voice message to calling party 121. The call is released by call application 306 or the network element 101-103.

If called party 131 selects the third answering message option, then call application 306 (see FIG. 3) initiates the process of transmitting a voice message to calling party 121 stating “I'm in a meeting right now, hold on while I excuse myself out of the meeting.” As in the previous example, call application 306 or a network element 101-103 may provide the voice message of the third answering message option. Call application 306 in this example maintains the call after the voice message is transmitted.

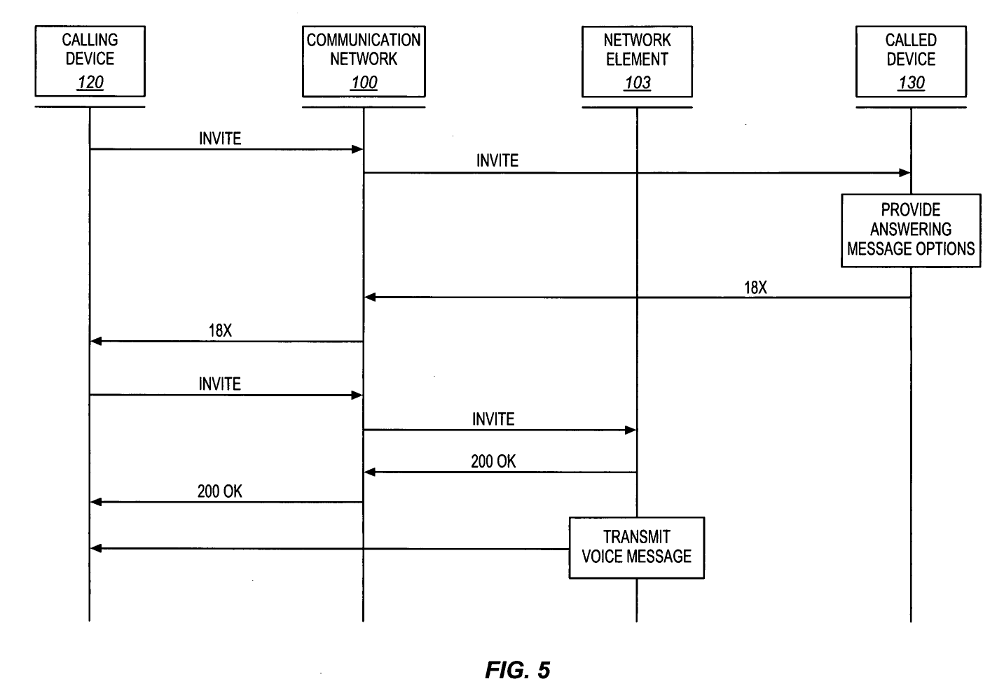

FIGS. 5-7 are signaling diagrams illustrating an exemplary operation of communication network 100 and devices 120 and 130. In the examples in FIGS. 5-7, communication network 100 comprises an IMS network, and calling device 120 and called device 130 comprise SIP-enabled devices.

FIG. 5 is a signaling diagram illustrating an example where a network element 103 provides a voice message to calling party 121 to answer a call for called party 131. Called party 131 predefines one or more answering messages to answer a call that is stored in network element 103. Called party 131 may also predefine one or more answering messages that are stored in called device 130 or other network elements. Network element 103 may comprise an application server or feature server in an IMS network.

To initiate a call from calling party 121 to called party 131, calling device 120 transmits a SIP INVITE message to communication network 100. Communication network 100 forwards the INVITE message to called device 130. Responsive to receiving the INVITE message, called device 130 identifies a plurality of answering messages predefined by called party 131. Called device 130 provides the answering message options to called party 131 (see FIG. 4) based on the identified answering messages. Assume for this example that called party 131 selects the second answering message option displayed in FIG. 4. Responsive to the selection by called party 131, called device 130 transmits a SIP 18X message to communication network 100. Communication network 100 forwards the 18X message to calling device 120. The 18X message includes a URL to network element 103 having the selected voice message predefined by called party 131. In other embodiments, the 18X message may include other indications for connecting calling device 120 to network element 103. Responsive to receiving the URL in the 18X message, calling device 120 transmits an INVITE message to network element 103. Responsive to the INVITE message, network element 103 transmits a SIP 200 OK message to calling device 120. Network element 103 then transmits the voice message “I'm in a meeting right now, please press 1 to leave a voice mail message” to calling party 121. The call is then released or redirected to voice mail as appropriate.

A call session is not established between calling party 121 and called party 131 to provide the voice message to calling party 121. Network element 103 provides the voice message to calling party 121 for called party 131.

In other embodiments, responsive to the selection by called party 131, called device 130 may transmit a SIP redirection message, such as SIP 302 message, which causes the session to be connected to network element 103 where the voice message interaction occurs.

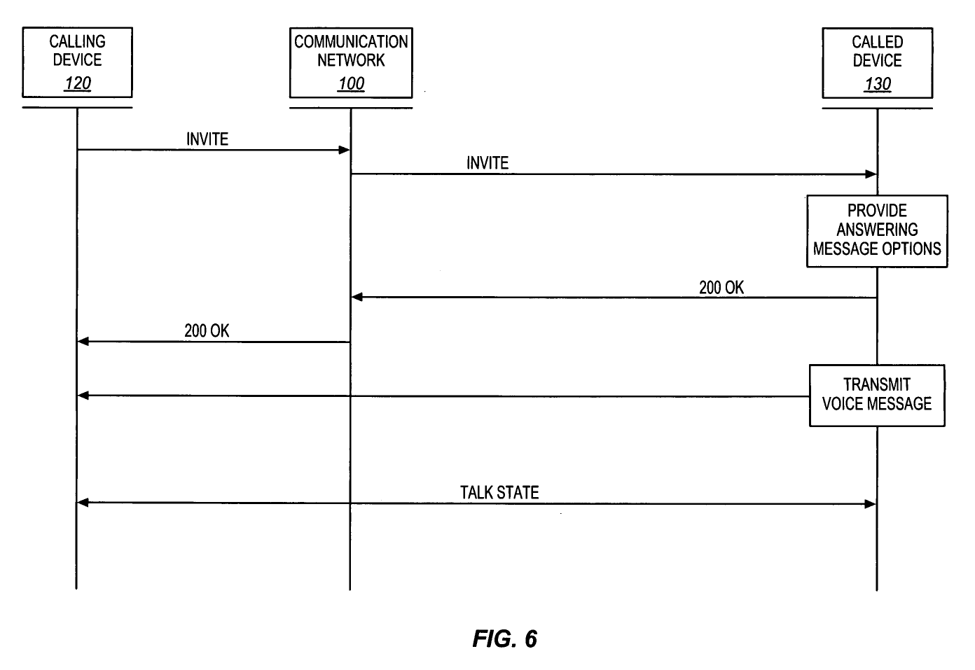

FIG. 6 is a signaling diagram illustrating an example where called device 130 provides a voice message to calling party 121 to answer a call for called party 131. Called party 131 predefines one or more answering messages to answer a call that is stored in called device 130. Called party 131 may also predefine one or more answering messages that are stored in a network element 101-103 (see FIG. 1).

To initiate a call from calling party 121 to called party 131, calling device 120 transmits a SIP INVITE message to communication network 100. Communication network 100 forwards the INVITE message to called device 130. Responsive to receiving the INVITE message, called device 130 identifies a plurality of answering messages predefined by called party 131. Called device 130 provides the answering message options to called party 131 (see FIG. 4) based on the identified answering messages. Assume for this example that called party 131 selects the third answering message option displayed in FIG. 4. Responsive to the selection by called party 131, called device 130 transmits a SIP 200 OK message to calling device 120 over communication network 100. Calling device 120 receives the 200 OK message, and a call session is established between calling device 120 and called device 130.

With the call session established, called device 130 transmits the voice message “I'm in a meeting right now, hold on while I excuse myself out of the meeting” to calling device 120. The voice message, as played by called device 130, answers the call for the called party 131. Called party 131 did not have to actually speak into called device 130 to answer the call. The call session is maintained after the voice message is played to calling party 121, and called party 131 can speak to calling party 121 when he/she is out of the meeting.

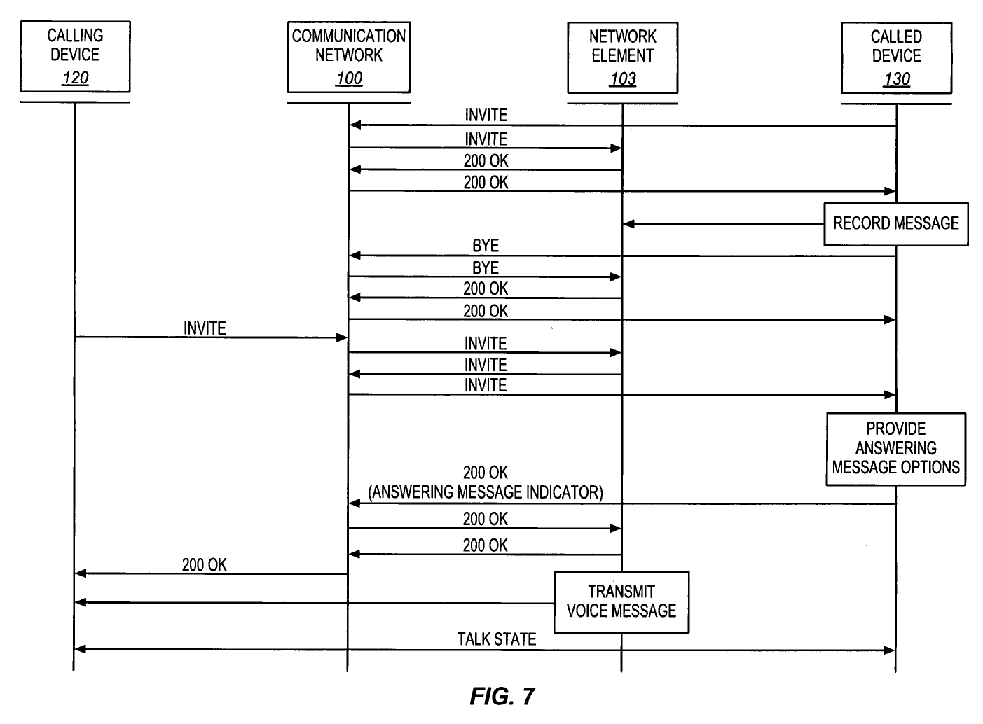

FIG. 7 is a signaling diagram illustrating another example where a network element 103 provides a voice message to calling party 121 to answer a call for called party 131. Called party 131 predefines one or more answering messages to answer a call that is stored in network element 103. Called party 131 may also predefine one or more answering messages that are stored in called device 130 or other network elements. Network element 103 may comprise an application server or feature server in an IMS network.

To store the predefined answering message, called device 130 transmits a SIP INVITE message to communication network 100, which forwards the INVITE message to network element 103. Network element 103 responds to called device 130 with a SIP 200 OK message through communication network 100. A session is thus established to allow called party 131 to deposit a customized answering message in network element 103. Called party 131 then records the answering message in network element 103 to say “I'm in a meeting right now, hold on while I excuse myself out of the meeting”. Network element 103 stores the answering message. Called device 130 then transmits a SIP BYE message to network element 103 through communication network 100. Network element 103 responds to the BYE message with a SIP 200 OK message.

Called party 131 may record multiple voice messages, text messages, video messages, or any other type of multi-media messages in network element 103 during the session. Called party 131 may also initiate other sessions as described above to record other answering messages at other times.

Calling party 121 then places a call to called party 131. To initiate the call, calling device 120 transmits a SIP INVITE message to communication network 100. Communication network 100 forwards the INVITE message to network element 103. The INVITE message provides network element 103 with the information on calling party 121 and/or calling device 120 in the event that network element 103 needs to provide an answering message for called party 131.

Communication network 100 then forwards the INVITE message to called device 130. Responsive to receiving the INVITE message, called device 130 identifies a plurality of answering messages predefined by called party 131. Called device 130 provides the answering message options to called party 131 (see FIG. 4) based on the identified answering messages. Assume for this example that called party 131 selects the third answering message option displayed in FIG. 4. Responsive to the selection by called party 131, called party 130 transmits a SIP 200 OK message to network element 103 through communication network 100. The 200 OK message includes an answering message indicator that indicates the answering message selected by called party 131. Responsive to the 200 OK message, network element 103 transmits a 200 OK message to calling device 120 to establish a session with calling device 120. With the session established, network element 103 transmits the voice message “I'm in a meeting right now, hold on while I excuse myself out of the meeting” to calling party 121. After network element 103 transmits the voice message to calling party 121, the session is torn down in a conventional manner (not shown in FIG. 7).

The voice message, as played by network element 103, answers the call for the called party 131. Called party 131 did not have to actually speak into called device 130 to answer the call. After the voice message is played by network element 103, a call session is established between calling party 121 and called party 131 in a conventional manner (not shown in FIG. 7). Called party 131 can then speak to calling party 121 when he/she is out of the meeting.

By providing the answering message options to called party 131 as described above, called party 131 can answer the call from calling party 121 in a non-traditional manner. Called device 130 may answer the call for called party 131, or one or more network elements 101-103 may answer the call for called party 131. Called party 131 thus has more flexibility in how to answer calls.

Along with providing the answering message options to called party 131, called device 130 may provide information associated with the call or with calling party 121. Many current communication devices are enabled to receive and display caller ID information on a calling party. According to aspects and features hereof, called device 130 may additionally provide subject information for the call to called party 131.

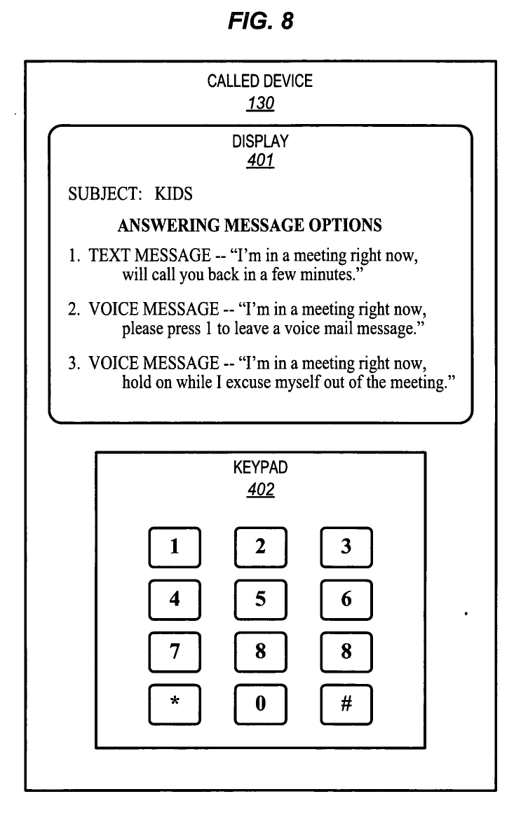

FIG. 8 illustrates another exemplary screen displayed by called device 130 in an exemplary embodiment of the invention. In FIG. 8, called device 130 is displaying subject information of “Kids” to called party 131 along with the answering message options. Called party 131 thus knows that the incoming call has something to do with his/her kids. This may influence the answering message option selected by called party 131.

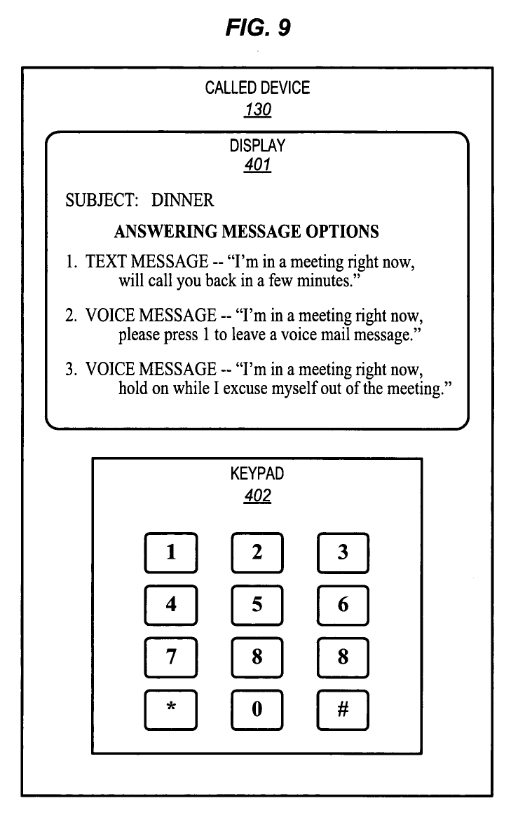

FIG. 9 illustrates another exemplary screen displayed by called device 130 in an exemplary embodiment of the invention. In FIG. 9, called device 130 is displaying subject information of “Dinner” to called party 131 along with the answering message options. Called party 131 thus knows that the incoming call has something to do with dinner.

Providing subject information to called party 131 may be implemented in many desired manners. For instance, assume that communication network 100 (see FIG. 1) comprises a SIP-based IMS network. SIP provides for a subject header in SIP messages, such as in SIP INVITE messages. When placing a call, calling party 121 may include subject information for the call (e.g., “kids”, “dinner”, “urgent”, etc). Calling device 120 then includes the subject information in the SIP INVITE message transmitted to called device 130. Responsive to receiving the INVITE message, called device 130 identifies the subject information in the subject header, and displays the subject information to called party 131. Called party 131 may then view the subject information to decide how to answer the call.

Although specific embodiments were described herein, the scope of the invention is not limited to those specific embodiments. The scope of the invention is defined by the following claims and any equivalents thereof.

We claim:

1. A method of providing options to a called party for answering a call from a calling party, the method comprising:
receiving a call to a called device of the called party from a calling device of the calling party;
identify, responsive to receiving the call, a plurality of answering messages predefined by the called party;
providing answering message options for answering the call to the called party using the called device based on the identified answering messages; and
transmitting an answering message to the calling device of the calling party responsive to a selection of one of the answering message options by the called party.

2. The method of claim 1 wherein the answering message comprises a text message, a voice message, a video message, or a picture message.

3. The method of claim 1 wherein the answering message indicates the availability of the called party for answering the call.

4. The method of claim 1 wherein providing answering message options comprises:
displaying a menu of the identified answering messages to the called party using the called device responsive to receiving the call.

5. The method of claim 4 further comprising:
allowing real-time selection of the identified answering messages by the called party that are displayed in the menu.

6. The method of claim 1 wherein transmitting an answering message to the calling device comprises:
transmitting the answering message from the called device to the calling device.

7. The method of claim 1 wherein transmitting an answering message to the calling device comprises:
transmitting an answering message indicator of the selection of one of the answering message options by the called party from the called device to a network element in a network connecting the called device to the calling device; and
transmitting the answering message from the network element to the calling device responsive to the network element receiving the answering message indicator.

8. The method of claim 7 wherein the network comprises an IMS network.

9. The method of claim 7 wherein the network comprises a circuit-based network.

10. The method of claim 1 further comprising:
releasing the call after transmitting the answering message to the calling party.

11. The method of claim 1 further comprising:
maintaining the call after transmitting the answering message to the calling party.

12. A communication device adapted to provide options to a called party for answering a call from a calling party, the communication device comprising:
a user interface; and
a call application executable by a processing system, wherein responsive to receiving a call from a calling device of the calling party, the call application is adapted to direct the processing system to identify a plurality of answering messages predefined by the called party, provide answering message options for answering the call to the called party based on the identified answering messages, and transmit an answering message to the calling device of the calling party responsive to a selection of one of the answering message options by the called party.

13. The communication device of claim 12 wherein the answering message comprises one of a text message, a voice message, a video message, or a picture message.

14. The communication device of claim 12 wherein the call application is further adapted to:
display a menu of the identified answering messages to the called party responsive to receiving the call.

15. The communication device of claim 14 wherein the call application is further adapted to:
allow real-time selection of the answering messages by the called party that are displayed in the menu.

16. The communication device of claim 12 wherein the answering message to the calling device indicates the availability of the called party for answering the call.

17. The communication device of claim 12 wherein the call application is further adapted to:
release the call after transmitting the answering message to the calling party or maintain the call after transmitting the answering message to the calling party.

18. The communication device of claim 12 wherein the call application is further adapted to:
transmit an answering message indicator of the selection of one of the answering message options by the called party to a network element in a network connecting the called device to the calling device to allow the network element to transmit the answering message to the calling party.

19. A method of operating a called device of a called party for answering a call from a calling party, the method comprising:
receiving a call from a calling device of the calling party;
identifying a plurality of answering messages predefined by the called party responsive to receiving the call;
providing answering message options for answering the call to the called party based on the identified answering messages; and
transmitting an answering message to the calling device of the calling party responsive to a selection of one of the answering message options by the called party.

20. The method of claim 19 wherein the answering message indicates the availability of the called party for answering the call.
